(19) United States
(12) Patent Application Publication
(10) Pub. No.: US 2019/0195221 A1
(43) Pub. Date: Jun. 27, 2019

(54) HYBRID METAL-PLASTIC PARTS AND PROCESS FOR MANUFACTURING THE SAME

(71) Applicant: SABIC Global Technologies B.V., Bergen op Zoom (NL)

(72) Inventors: Somasekhar BOBBA VENKAT, East Greenbush, NY (US); RN Ashwin KUMAR, Bangalore (IN); Harindranath K. SHARMA, Bangalore (IN); Subhransu Sekhar MOHAPATRA, Bangalore (IN); Fred CHANG, Wixom, MI (US); Lenar ABBASOV, West Bloomfield, MI (US)

(21) Appl. No.: 16/063,109

(22) PCT Filed: Dec. 15, 2016
(86) PCT No.: PCT/US2016/066758

§ 371 Date: Jun. 15, 2018

(30) Foreign Application Priority Data
Dec. 23, 2015 (IN) 4250/DEL/2015

(51) Int. Cl. F04C 2/344; B22F 3/22; B22F 3/16; B29C 45/14; F01C 21/10

(52) U.S. Cl. CPC F04C 2/344; B22F 3/225; B22F 3/16; B29K 2705/12; F01C 21/106; B22F 2301/35; B29C 45/14

(57) ABSTRACT

A process for constructing a hybrid material part includes mixing a metal powder and a binder to form a compounded mixture, heating the compounded mixture, injecting the compounded mixture into a first mold to form a green part, and debinding the green part to form a brown part. The process further includes sintering the brown part to form a sintered part, and over-molding the sintered part with a plastic in a second mold of an injection molding machine to form the hybrid material part. A hybrid material pump part is disclosed as well.

### TECHNICAL FIELD

This disclosure pertains generally, but not by way of limitation, to a hybrid metal-plastic process for manufacturing parts. This disclosure further pertains generally, but not by way of limitation, to a hybrid metal-plastic part.

### BACKGROUND OF THE DISCLOSURE

Reducing a weight of vehicle parts is one of the ways to achieve automotive fuel efficiency targets as per the Corporate Average Fuel Economy (CAFE) guidelines. Automotive manufactures are aggressively exploring various lightweight solutions, including material and design, to achieve the fuel efficiency targets.

In this regard, typical metallic vehicle parts exhibit excellent strength characteristics. However, these metallic vehicle parts are also typically heavier than similar plastic parts. Plastic vehicle parts exhibit reduced weight, however the plastic vehicle parts are not preferred in numerous applications where strength and wear resistance are important considerations.

For example, vehicle parts such as pumps have numerous uses in vehicles. Pumps can be used to move various fluids through key parts of the vehicle. The pumps can be oil pumps, coolant pumps, fuel pumps, diesel exhaust fluid pumps, and the like. Each of these pump applications needs to be reliable as their failure can result in operational failure of the vehicle or in a worst-case scenario, catastrophic damage to the engine and/or the vehicle.

The present inventors have recognized, among other things, that vehicle parts can benefit from being lighter in weight along with having high strength and high wear resistance. The present disclosure can help provide a solution to this problem by utilizing a manufacturing process that includes a metal injection molding process together with a plastic injection molding process to construct hybrid metal-plastic parts with, amongst other things, high strength and lighter weight.

### SUMMARY OF THE DISCLOSURE

According to an aspect of the disclosure, a process for constructing a hybrid material part includes mixing a metal powder and a binder to form a compounded mixture, heating the compounded mixture, injecting the compounded mixture into a first mold to form a green part, debinding the green part to form a brown part, sintering the brown part to form a sintered part, and over-molding the sintered part with a plastic in a second mold of an injection molding machine to form the hybrid material part.

According to an aspect of the disclosure, a hybrid material pump part includes a first housing portion formed with a metal powder and a binder injection molded structure, a second housing portion formed by a plastic structure over-molded onto the first housing portion, a drive hub arranged in the first housing portion, a plurality of slots arranged in the drive hub, and a plurality of vanes arranged in the plurality of slots, wherein the plurality of vanes form a seal with the first housing portion.

This overview is intended to provide an overview of subject matter of the present patent application. It is not intended to provide an exclusive or exhaustive explanation of the disclosure. The detailed description is included to provide further information about the present patent application.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

In the drawings, which are not necessarily drawn to scale, like numerals may describe similar parts in different views. Like numerals having different letter suffixes may represent different instances of similar parts. The drawings illustrate generally, by way of example, but not by way of limitation, various aspects discussed in the present document.

FIG. 1 illustrates a process for constructing hybrid metal-plastic parts according to principles of the disclosure.

FIG. 2 illustrates details of the structural changes to a metal portion of the hybrid metal-plastic part during manufacturing according to principles of the disclosure.

FIG. 3 illustrates details of the structural changes to a metal portion of the hybrid metal-plastic part during manufacturing according to principles of the disclosure.

FIG. 4 illustrates various stages of a hybrid metal-plastic part during manufacturing according to principles of the disclosure.

FIG. 5 illustrates a hybrid metal-plastic part implemented as part of a pump according to the principles of the disclosure.

FIG. 6 illustrates a metal injected molding portion of a hybrid metal-plastic part of FIG. 5.

FIG. 7 illustrates a combined metal injected molding portion and a plastic injected molding portion of a hybrid metal-plastic part of FIG. 5.

### DETAILED DESCRIPTION OF THE DISCLOSURE

The aspects of the disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known parts and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

This disclosure presents a process to manufacture hybrid metal-plastic parts. In one aspect, the disclosure presents hybrid metal-plastic parts. In one aspect, the disclosure presents a process to manufacture hybrid metal-plastic vehicle parts. In one aspect, the disclosure presents hybrid metal-plastic vehicle parts. In one aspect, the disclosure presents hybrid metal-plastic vehicle pump parts. In one aspect, the disclosure presents a process to manufacture hybrid metal-plastic vehicle pump parts. The hybrid metal-plastic parts of the disclosure can save weight and improve efficiency while maintaining equal performance in terms of dimensional stability and structural integrity.

The process to manufacture hybrid metal-plastic vehicle parts may include a two shot molding process with a first shot to build a metal injection molding (MIM) part and a second shot with filled thermoplastic, or other high strength and temperature resistant materials, to form a final part over the MIM part.

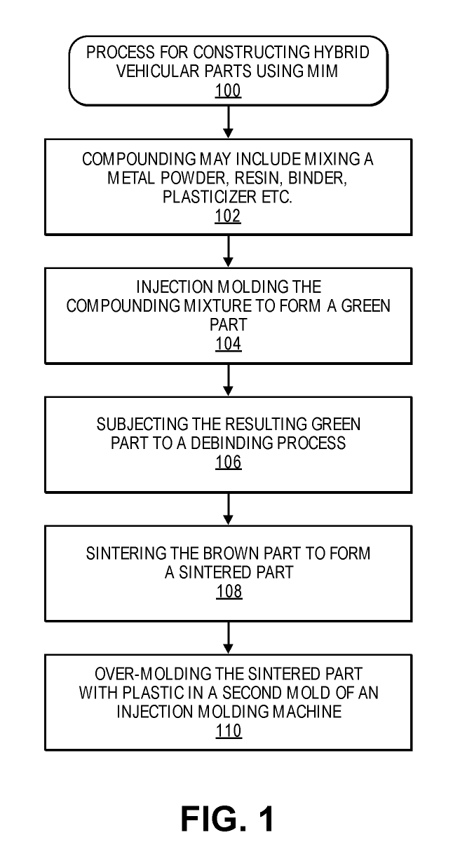

FIG. 1 illustrates a process for constructing hybrid metal-plastic parts according to principles of the disclosure. In particular, the process 100 is generally directed to molding a metal injected part using a metal injection molding (MIM) process. The process may further include subsequently over-molding the metal injected part with a plastic, such as a plastic resin. In one aspect, the over-molding may be implemented using injection molding. The process 100 may further include the following steps outlined below.

As shown in box 102, materials for the MIM process may be prepared in a compounding process. The compounding may include mixing a metal powder and a binder and/or plastic in preparation for molding. In one aspect, the compounding may include mixing 30 to 70% by weight of a metal powder with the binder and/or plastic. In one aspect, the compounding may include mixing 30 to 40% by weight of a metal powder with the binder and/or plastic. In one aspect, the compounding may include mixing 40 to 50% by weight of a metal powder with the binder and/or plastic. In one aspect, the compounding may include mixing 50 to 60% by weight of a metal powder with the binder and/or plastic. In one aspect, the compounding may include mixing 60 to 70% by weight of a metal powder with the binder and/or plastic.

In one aspect, the compounding may further include mixing the metal powder and the binder with a resin, a plasticizer and/or the like in preparation for molding. In one aspect, the compounding may further contain other additives such as, dispersants, stabilizers, lubricants and/or the like. The resulting compounded mixture results in a feedstock.

As shown in box 104, the compounded mixture may be injection molded. In this regard, the feedstock may be heated to melt one or more of the materials. For example, one or more of the binder, resin, plastic or the like may be heated to a temperature to melt the same. In one aspect, the metal powder is not melted. The resulting heated feedstock may then be injected into a first mold to form the MIM part into a desired shape. The resulting MIM part is a green part.

As shown in box 106, the resulting green part may be subjected to a debinding process. Various debinding processes may be utilized for removal of the binders from the molded green part. The debinding processes may include thermal debinding, catalytic debinding, solvent debinding, and the like. The resulting debinded part is a brown part.

In one aspect that includes thermal debinding, the thermal debinding may include heating in a thermal process. The thermal process may result in at least partial evaporation of the binder material.

In one aspect that includes catalytic debinding, the catalytic debinding may include a binder system based on polyoxymethylene (POM), a polyacetal binder system, or the like. The binder removal in the catalytic debinding may be achieved in a gaseous acid environment. For example, a highly concentrated nitric acid, oxalic acid, or like acid at a temperature of approximately 120° C. or other temperature that is below a softening temperature of the binder. The acid may act as a catalyst in a decomposition of the polymer binder.

In one aspect that includes solvent debinding, the solvent debinding process may include a binder composition that includes a constituent that can be dissolved in a liquid at low temperature. For example, water, acetone, heptane and/or the like may be used as the solvent for the debinding process.

Next, the brown part may be subjected to sintering 108. In this regard, the debinded brown part may be heated to make a more dense solid part by a reduction and/or elimination of pores. The resulting sintered part may have a density 98% of a theoretical density. The resulting sintered part may then be subjected to additional secondary operations. The secondary operations may include machining, painting, and the like.

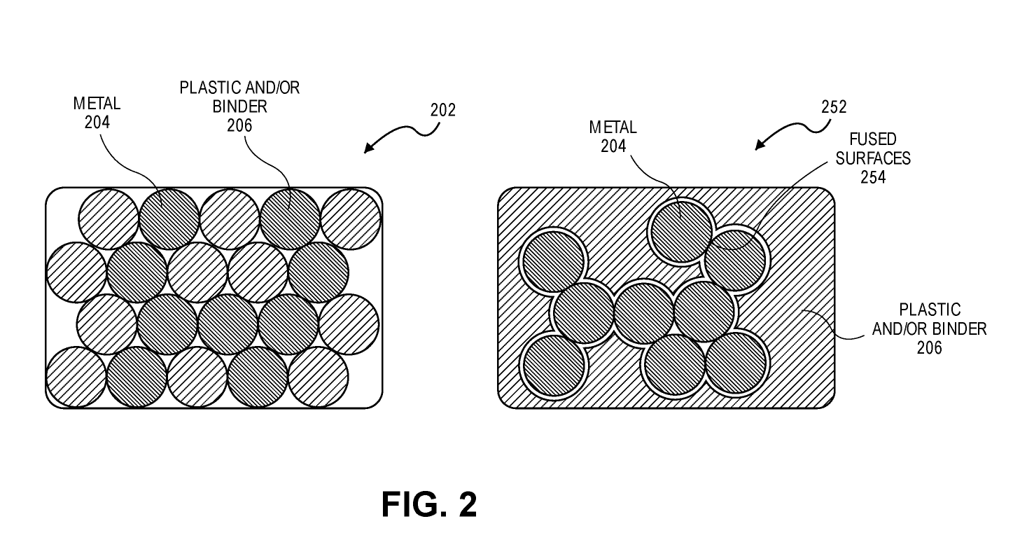

FIG. 2 illustrates details of the structural changes to a metal portion of a hybrid metal-plastic part during manufacturing according to principles of the disclosure. In one aspect, the sintering process may be implemented so that not all the binder material is removed from the MIM part. Therefore, the resulting part from this sintering process may be a part which is partially porous. In one aspect, the part may be a porous part with some amount of binder material present in the part after sintering. In one aspect, the part may be a porous part with 2 to 20% of binder material present in the part after sintering. In one aspect, the part may be a porous part with 2 to 10% of binder material present in the part after sintering. In one aspect, the part may be a porous part with 10 to 20% of binder material present in the part after sintering.

As shown in FIG. 2, a green part 202 includes metal portions 204 and plastic and/or binder portions 206. After the debinding process described in box 106 and the sintering process described in box 108, the resulting sintered part 252 may include the metal portions 204. In one aspect, the metal portions 204 may have at least partially fused along a surface 254 to other metal portions 204. In one aspect, the plastic and/or binder portions 206 may have transformed and now fill the gap between the metal portions 204. In one aspect, the sintering process of the process 100 may include heating the part to temperatures where the powder of the metal portions 204 undergoes metallurgical changes so as to fuse the material to form a dense solid part.

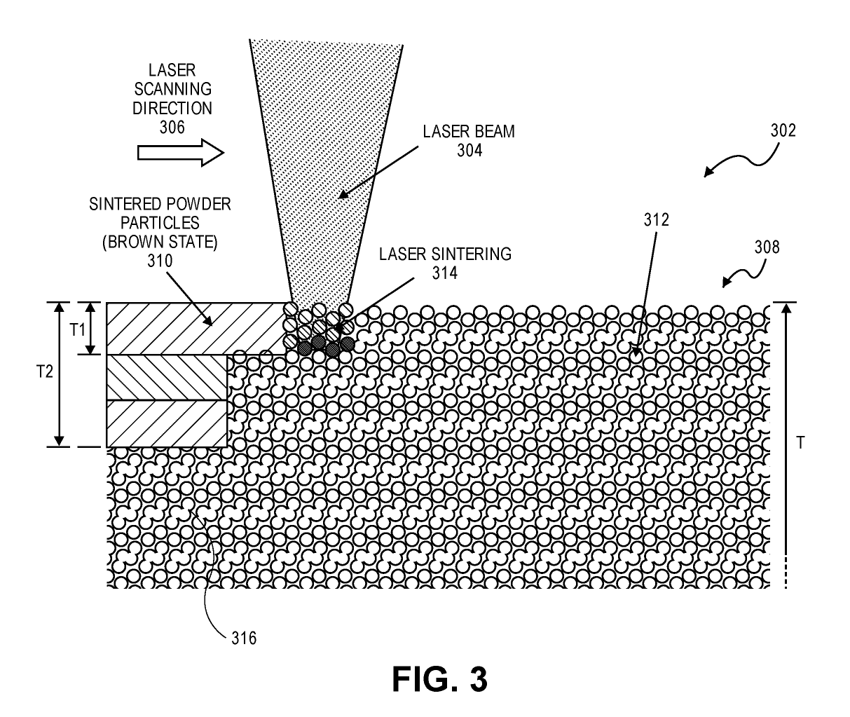

FIG. 3 illustrates details of the structural changes to a metal portion of a hybrid metal-plastic part during manufacturing according to principles of the disclosure. In a particular aspect, the brown part may be subjected to selective sintering. The selective sintering may utilize localized heating that may be achieved rapidly by a laser, an infrared (IR) source, or the like. In one aspect, the selective sintering may involve the use of a high power laser to fuse small particles of plastic, metal, and/or the like. In a particular aspect, the selective sintering may involve the use of a high power carbon dioxide laser to fuse small particles of plastic, metal, and/or the like. In one aspect, the laser may selectively fuse the material by scanning cross-sections of the part. In one aspect, the laser may selectively fuse the material by scanning cross-sections generated from a 3-D digital description of the part.

In one aspect, the laser may be a pulsed laser. In a particular aspect, the brown parts may be subjected to selective sintering as described above. The advantages of this process is reduced sintering time compared to full sintering, metal rich outer layers and a plastic core for wear resistant applications, controlled sintering thickness according to application, and the like.

In one aspect, the process may include a sintering process to selectively heat the MIM part so that sintering occurs only in local regions. In a further aspect, the sintering may be implemented to a controlled thickness of the part. This selective sintering process may reduce a cycle time. As shown in FIG. 3, a thickness of part is indicated as T. In one aspect, the part may be sintered up to a thickness of T1 or a thickness of T2 according to the application. In one aspect, the thickness to be sintered can be from 20 to 50% of the part thickness T. In one aspect, the thickness to be sintered can be from 20 to 30% of the part thickness T. In one aspect, the thickness to be sintered can be from 30 to 40% of the part thickness T. In one aspect, the thickness to be sintered can be from 40 to 50% of the part thickness T. In one aspect, the thickness T1 may be from 20 to 50% of the part thickness T. In one aspect, the thickness T2 may be from 20 to 50% of the part thickness T.

In one aspect, the part 302 may be selectively sintered using a laser process. The laser process may include formation of a laser beam 304 that may be controlled and moved across a surface 308 of the part 302. As shown in FIG. 3, the laser beam 304 may scan in the direction 306 as shown by the arrow. The surface 308 is shown with a sintered portion 310 where the laser beam 304 has implemented the selective sintering process. The surface 308 is further shown with a portion 312 that has not yet been sintered. Finally, the surface 308 is further shown with a portion 314 that is shown being sintered.

Based on a control of power, time, frequency, and the like, the laser beam 304 may selectively sinter some portions to a depth of T2 and selectively sinter other portions to a depth of T1. In one aspect, the laser beam 304 may selectively sinter some portions to a depth of T1. In one aspect, the laser beam 304 may selectively sinter some portions to a depth of T2. In one aspect, a portion of the part 302 may have a sintered portion 310 and a portion of the part 302 without sintering the material 316.

Returning to FIG. 1, in one aspect the sintered part may be over-molded with a plastic, such as a plastic resin. In another aspect, the sintered part may be molded with a plastic, such as a plastic resin. In another aspect, the sintered part may then be placed in a second mold of an injection molding machine and over-molded as described in box 110 with a plastic, such as a plastic resin.

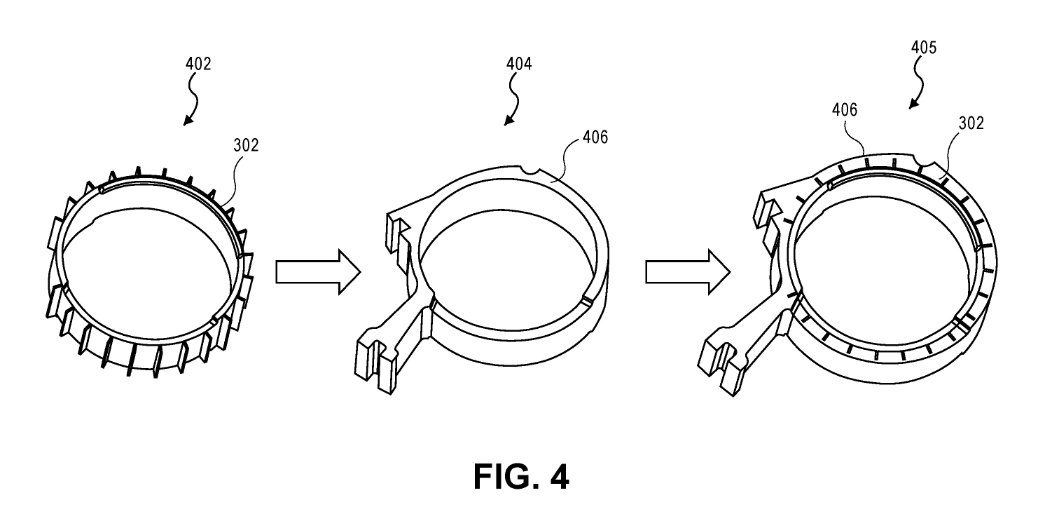

FIG. 4 illustrates various stages of a hybrid metal-plastic part during manufacturing according to principles of the disclosure. In particular, FIG. 4 illustrates in section 402 the part 302 that may be manufactured consistent with the process 100 including box 102, box 104, box 106, and box 108. In section 404, the plastic molded portion 406 only is shown. In section 405 the part 302 and plastic molded portion 406 are shown combined that may be manufactured consistent with the process 100 including box 110.

The resulting MIM part over-molded with the plastic resin is a hybrid metal-plastic construction where metal members may take the load and protect the plastic part. Moreover, the process of constructing the MIM part over-molded with a plastic resin has a number of advantages including broad metal material selection for specific requirements and greater design freedom of the metal member to achieve better bonding. This process can be applicable to all the applications where reducing weight can be advantageous.

Aspects of the disclosure may be directed to parts for automotive applications, aerospace applications and other applications. In some aspects, the parts may be implemented in automotive applications such as rocker arms, turbochargers vanes, shift lever components, and the like. In some aspects, the parts may be implemented in automotive applications such body parts, doors parts, windows parts, charging system parts, electrical supply system parts, gauge and meter parts, ignition electronic system parts, lighting and signaling system parts, sensor parts, starting system parts, switch parts, interior parts, powertrain and chassis parts, braking system parts, engine component parts, engine cooling system parts, engine oil system parts, fuel supply system parts, suspension and steering systems parts, transmission system parts, and the like. In some aspects, the parts may be implemented in aerospace applications such as seatbelt components, turbine components, valve holders, and the like. In some aspects, the parts may be implemented in aerospace applications such as fuselage parts, doors parts, windows parts, electrical supply system parts, gauge and meter parts, lighting and signaling system parts, sensor parts, switch parts, interior parts, braking system parts, engine component parts, engine oil system parts, fuel supply system parts, and the like. In some aspects, the parts may be implemented in other applications such as pump housing components, heat sinks, transceiver housings, and the like.

In a particular aspect, the above-described process may be utilized for a pump application. In particular, parts of a pump. In a particular aspect, the above-described process may be utilized for an oil pump application. In particular, parts of the oil pump. In this regard, a vehicle engine always needs oil, an amount of oil needed depends on a speed and load at any given time. Typical oil pumps are driven off an engine and sized for a worst case condition the engine is expected to experience. As a result, typical oil pumps typically move more oil than needed, and the excess is dumped back to the oil pan through a bypass.

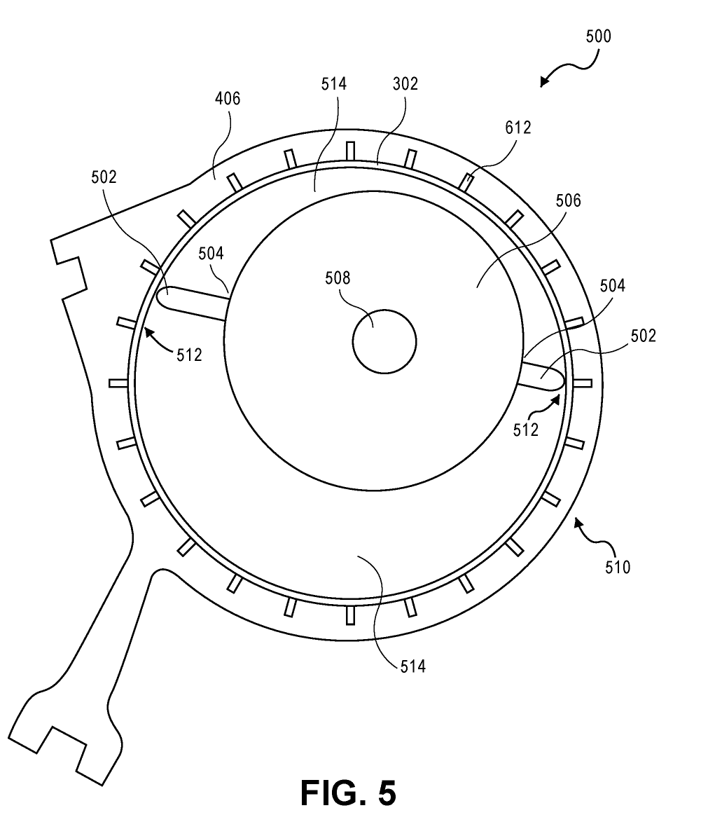

FIG. 5 illustrates a combined metal injected molding portion and a plastic injected molding portion implemented as part of a pump according to the principles of the disclosure. In some aspects, the disclosure is directed to pump parts such as parts for a variable displacement pump 500. In particular, FIG. 5 illustrates a portion of the variable displacement pump 500. In some aspects, the variable displacement pump 500 may be intelligently controlled so that the variable displacement pump 500 is controlled to operate to pump only as much fluid as needed. For example, the variable displacement pump 500 may be implemented as an oil pump and operated to pump oil based on the engine needs.

The variable displacement pump 500 may include spring-loaded vanes 502 arranged in slots 504 in a drive hub 506 of the pump 500. In this regard, the slots 504 may include one or more springs (not shown) arranged therein. The springs contact the vanes 502 and urge the vanes 502 out of the drive hub 506. The spring-loaded vanes 502 contact a surface 512 of the part 302. The spring-loaded vanes 502 may be configured to slide into and out of the drive hub 506 and seal on all edges including the surface 512 to form vane chambers 514 that provide the pumping work. On an intake side of the pump 500, the vane chambers 514 are increasing in volume during rotation of the drive hub 506.

The increasing volume of the vane chambers 514 are filled with fluid forced in by an inlet pressure. On a discharge side of the pump 500, the vane chambers 514 are decreasing in volume, forcing fluid out of the pump 500. The action of the spring-loaded vanes 502 drive out a volume of fluid with each rotation of the drive hub 506.

The drive hub 506 rotates in an off-center manner about an axis 508 with respect to a pump housing 510. As the drive hub 506 rotates from a pump inlet to a pump outlet (not shown), the spring-loaded vanes 502 are pushed in and the vane chambers 514 between them becomes smaller causing the fluid pressure to rise. A larger difference between the inlet and outlet volume causes greater oil pressure and flow. The pump housing 510 of the pump 500 may be mounted on a pivot, which allows the center of the pump housing 510 to move closer to the center of the drive hub 506. This reduces the volume in the pump 500 and the resulting fluid flow.

As further shown in FIG. 5, the pump housing 510 may include the part 302 that is the MIM part. The pump housing 510 may further include the plastic molded portion 406. Accordingly, the part 302 may form a first portion of the pump housing 510 and the plastic molded portion 406 may form a second portion of the pump housing 510. The part 302 may include the surface 512 that is subjected to a high wear environment due to the contact with the spring-loaded vanes 502. The part 302 may further include a generally circular internal surface to contact the spring-loaded vanes 502. In one aspect, utilizing the part 302 having a metallic construction in this configuration provides good thermal conductivity as well as good wear resistance.

In one aspect, the part 302 may further include one or more fins 612. In one aspect, the fins 612 may help conduct heat away from the surface 512. Moreover, the fins 612 may further provide excellent structural integration with the plastic molded portion 406.

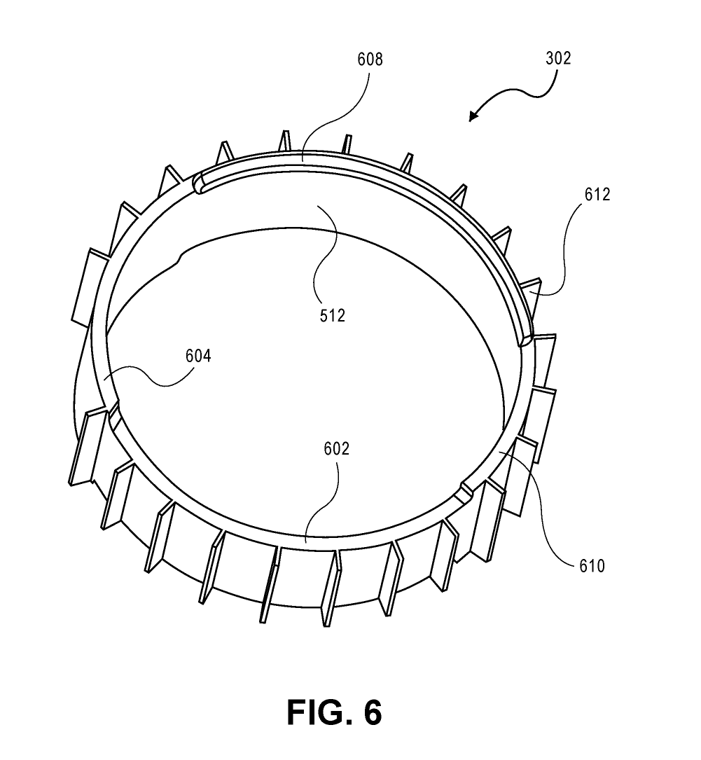

FIG. 6 illustrates a metal injected molding portion of a hybrid metal-plastic vehicle part according to the principles of the disclosure. In particular, FIG. 6 shows details of the fins 612. In one aspect, the fins 612 may have a generally rectangular form and extend radially outwardly from the part 302. However, other configurations of the fins 612 are contemplated as well. In one aspect, the part 302 may have a top surface that includes different height portions 602, 604, 608, and 610. In one aspect, the different height portions 602, 604, 608, and 610 may be configured to mate with corresponding portions on another part of the pump 500 (not shown).

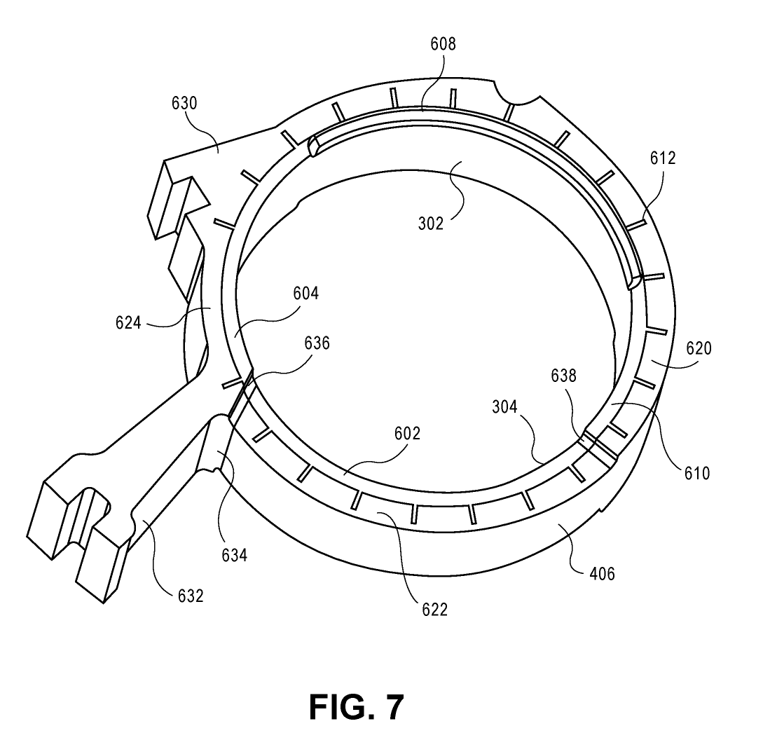

FIG. 7 illustrates a combined metal injected molding portion and a plastic injected molding portion of a hybrid metal-plastic vehicle part according to the principles of the disclosure. In particular, FIG. 7 shows the part 302 combined with the plastic molded portion 406. The plastic molded portion 406 may include different height portions 622, 624, and 620, that may correspond to different height portions 602, 604, and 610 of the part 302. Additionally, the part 302 and the plastic molded portion 406 may include transitions 636 and 638 between the different height portions.

In one aspect, the plastic molded portion 406 may further include a first extension 630 that may extend from an outer surface of the plastic molded portion 406 and a second extension 632 for rigid connection to other components, the engine, and/or the vehicle. The second extension 632 may further include a chamfered surface 634 to increase the strength thereof.

The final part from the disclosed process may retain a certain amount of plastic material which may have several advantages including combined properties of both metal and plastic, a reduced coefficient of thermal expansion (CTE) as compared to an all plastic part, better adhesion of metal and plastic when over-molded with plastic for hybrid metal-plastic designs, reduced weight compared to fully dense MIM part, and the like. The hybrid metal-plastic parts of the disclosure can save weight and improve efficiency while maintaining equal performance in terms of dimensional stability and structural integrity.

In one aspect, the metal part will have good thermal conductivity as well as good wear resistant. This is expected to be achieved by an alloy of suitable metal powders. Moreover, the process of the disclosure provides excellent design freedom allowing for a minimum possible wall thickness. Additionally, the process of the disclosure allows for a complex design that may include heat dissipation features such as the fins 612.

In another aspect of the disclosure, the part 302 may alternatively be manufactured through additive manufacturing of metals such as selective laser sintering, electronic beam free form fabrication, electron beam melting, and/or the like.

The metal injection molding process of the disclosure includes metal powders and binders. The metal powders may include low alloy steels, stainless steels, tool steels, non-ferrous metals, refractory alloys metal, and specialty and superalloy metals. The metal powder low alloy steels may include low carbon steel, medium carbon steel, high carbon steel, and the like. The metal powder stainless steels may include Austenitic, Martensitic, Precipitation hardening, Ferritic, and the like stainless steels. The metal powder tool steels may include die steel, high speed steel, and the like. The metal powder non-ferrous metals may include copper, titanium, and the like. The metal powder refractory alloy metals may include a tungsten base and the like. The metal powder specialty and superalloy metals may include magnetic, electronic packing, high temperature, and the like metals.

The binder, such as a polymer binder, to be used may be chosen considering the overall functional requirement of the part. In one aspect, the polymer binder may be ULTEM™ powder. In one aspect, the binders may include wax binder and polymer based binder, polymer binder/polymer based binder, and the like. The wax and polymer based binders may include paraffin, microcrystalline, synthetic hydrocarbon, and oxidized polyethylene waxes, low-density polyethylene (LDPE), high-density polyethylene (HDPE), ethylene acrylic acid copolymer (EAA), ethylene propylene diene terpolyrner (EPDM), polypropylene (PP), polybutylene (PB), polystyrene (PS), Poly(methyl methacrylate) (PPMA), Polyoxymethylene (POM), and the like. The Polymer/Polymer based binders may include polyacetal binders with catalytic and non-catalytic debinding, polyethylene glycol, block co-polymers, polyamides, and the like.

In one aspect, the plastic resin of the hybrid metal-plastic construction may be filled polypropylene (PP) thermoplastic materials with another material (e.g., with elastomeric materials and/or thermoset materials), such as a filled thermoplastic polyolefin (TPO). Possible thermoplastic materials include polybutylene terephthalate (PBT); acrylonitrile-butadiene-styrene (ABS); polycarbonate; polycarbonate/PBT blends; polycarbonate/ABS blends; copolycarbonate-polyesters; acrylic-styrene-acrylonitrile (ASA); acrylonitrile-(ethylene-polypropylene diamine modified)-styrene (AES); phenylene ether resins; blends of polyphenylene ether/polyamide; polyamides; phenylene sulfide resins; polyvinyl chloride PVC; high impact polystyrene (HIPS); low/high density polyethylene (L/HDPE); expanded polypropylene (EPP); and thermoplastic olefins (TPO), as well as filled (e.g., glass filled) materials of above resins. For example, a lower member and, optionally the energy absorber, comprise Xenoy™ resin, which is commercially available from SABIC Innovative Plastics IP B.V. An exemplary filled resin is STAMAX™ resin, which is a long glass fiber filled polypropylene resin also commercially available from SABIC Innovative Plastics IP B.V.

In one aspect, the efficiency improvement attributable directly to the disclosed pump is less than one percent. In one aspect, the efficiency improvement attributable directly to the disclosed pump is approximately 0.5%. This benefit becomes more significant when compared against the benefit from a start/stop system. The complete start/stop system benefits by 5 to 10%.

Example 1. A process for constructing a hybrid material part comprising: mixing a metal powder and a binder to form a compounded mixture; heating the compounded mixture; injecting the compounded mixture into a first mold to form a green part; debinding the green part to form a brown part; sintering the brown part to form a sintered part; and over-molding the sintered part with a plastic in a second mold of an injection molding machine to form the hybrid material part.

Example 2. The process according to Example 1 further comprising arranging the hybrid material part in a pump.

Example 3. The process according to Examples 1-2 wherein the pump comprises a variable displacement pump.

Example 4. The process according to Examples 1-3 further comprising arranging a pump drive hub and vanes within the hybrid material part, wherein the vanes contact the sintered part of the hybrid material part.

Example 5. The process according to Examples 1-4 further comprising forming fins on the sintered part to dissipate heat.

Example 6. The process according to Examples 1-5 wherein the sintering comprises selective sintering via localized heating.

Example 7. The process according to Examples 1-6 wherein the localized heating comprises heating with at least one of the following: a laser source and an infrared source.

Example 8. The process according to Examples 1-7 wherein the localized heating comprises heating with a laser source.

Example 9. The process according to Examples 1-8 wherein the sintering comprises selective sintering to a controlled thickness.

Example 10. The process according to Examples 1-9 wherein the sintered part comprises a sintered portion and a portion without sintering.

Example 11. The process according to Examples 1-10 wherein the sintering includes heating the brown part to temperatures where the metal powder undergoes metallurgical changes so as to fuse the metal powder to form a dense solid sintered part.

Example 12. The process according to Examples 1-11 wherein the sintered part comprises a density 98% of a theoretical density.

Example 13. The process according to Examples 1-12 wherein the sintered part is partially porous.

Example 14. The process according to Examples 1-13 wherein the sintered part is partially porous with some amount of binder present in the sintered part after sintering.

Example 15. The process according to Examples 1-14 wherein the sintered part comprises a porous part with 2 to 20% of binder present in the sintered part after sintering.

Example 16. The process according to Examples 1-15 wherein the metal powder of the sintered part comprises metal portions partially fused along a surface to other metal portions.

Example 17. The process according to Examples 1-16 wherein the binder fills a gap between the metal portions of the sintered part.

Example 18. The process according to Examples 1-17 wherein the compounded mixture further includes at least one of the following: a resin, a dispersant, a stabilizer, a lubricant and a plasticizer.

Example 19. The process according to Examples 1-18 wherein the metal powder comprises 30% to 70% of the compounded mixture.

Example 20. The process according to Examples 1-19 wherein the debinding comprises at least one of the following: a thermal debinding process, a catalytic debinding process, and a solvent debinding process.

Example 21. The process according to Examples 1-20 wherein the sintering comprises selective sintering to a controlled thickness of 20 to 50% of a thickness of the brown part.

Example 22. The process according to Examples 1-21 further comprising scanning the laser source across a surface of the brown part.

Example 23. The process according to Examples 1-22 wherein the laser source comprises a pulsed laser.

Example 24. The process according to Examples 1-23 wherein the laser source comprises a high power carbon dioxide laser.

Example 25. The process according to Examples 1-25 wherein the laser source comprises a pulsed high power carbon dioxide laser.

Example 26. A hybrid material pump part comprising: a first housing portion formed with a metal powder and a binder injection molded structure; a second housing portion formed by over-molding the first housing portion with a plastic; a drive hub arranged in the first housing portion; a plurality of slots arranged in the drive hub; and a plurality vanes arranged in the slots, wherein the plurality of vanes form a seal with the first housing portion.

Example 27. The hybrid material pump part according to Example 26 further comprising fins on the first housing portion configured to dissipate heat.

Example 28. The hybrid material pump part according to Examples 26-27 wherein the fins comprise a generally rectangular form.

Example 29. The hybrid material pump part according to Examples 26-28 wherein the fins extend radially outwardly from the first housing portion into the second housing portion.

Example 30. The hybrid material pump part according to Examples 26-29 wherein the drive hub is configured to rotate about an axis that is off-center with respect to the center of the first housing portion.

Example 31. The hybrid material pump part according to Examples 26-30 wherein the first housing portion comprises a sintered structure configured with selective sintering via localized heating.

Example 32. The hybrid material pump part according to Examples 26-31 wherein the localized heating comprises heating with at least one of the following: a laser source and an infrared source.

Example 33. The hybrid material pump part according to Examples 26-32 wherein the metal powder of the first housing portion comprises metal portions partially fused along a surface to other metal portions.

Example 34. The hybrid material pump part according to Examples 26-33 wherein the binder fills a gap between the metal portions of the first housing portion.

Example 35. The hybrid material pump part according to Examples 26-34 wherein the metal powder comprises 30% to 70% of the first housing portion.

Example 36. The hybrid material pump part according to Examples 26-35 wherein the pump comprises a variable displacement pump.

Example 37. The hybrid material pump part according to Examples 26-35 wherein the first housing portion comprises a sintered portion and a portion without sintering.

Example 38. The hybrid material pump part according to Examples 26-37 wherein the first housing portion further includes at least one of the following: a resin, a dispersant, a stabilizer, a lubricant and a plasticizer.

Example 39. The hybrid material pump part according to Examples 26-38 wherein the localized heating comprises heating with a laser source.

Example 40. The hybrid material pump part according to Examples 26-39 wherein the vanes are configured to form a seal with respect to the first housing portion.

Example 41. The hybrid material pump part according to Examples 26-40 wherein the drive hub is configured to rotate about an axis.

Example 42. The hybrid material pump part according to Examples 26-41 wherein the localized heating comprises heating with at least one of the following: a laser source and an infrared source.

Example 43. The hybrid material pump part according to Examples 26-42 wherein the sintering comprises selective sintering to a controlled thickness.

Example 44. The hybrid material pump part according to Examples 26-43 wherein the sintering includes heating the brown part to temperatures where the metal powder undergoes metallurgical changes so as to fuse the metal powder to form a dense solid sintered part.

Example 45. The hybrid material pump part according to Examples 26-44 wherein the sintered part comprises a density 98% of a theoretical density.

Example 46. The hybrid material pump part according to Examples 26-45 wherein the first housing portion is partially porous.

Example 47. The hybrid material pump part according to Examples 26-46 wherein the first housing portion is partially porous with some amount of binder present in the sintered part after sintering.

Example 48. The hybrid material pump part according to Examples 26-47 wherein the first housing portion comprises a porous part with 2 to 20% of binder present in the sintered part after sintering.

Example 49. The hybrid material pump part according to Examples 26-48 wherein the first housing portion further includes at least one of the following: a resin, a dispersant, a stabilizer, a lubricant and a plasticizer.

Example 50. The hybrid material pump part according to Examples 26-49 wherein the metal powder comprises 30% to 70% of the compounded mixture.

Example 51. The hybrid material pump part according to Examples 26-50 wherein the first housing portion comprises selective sintering to a controlled thickness of 20 to 50% of a thickness of the brown part.

Example 52. The hybrid material pump part according to Examples 26-51 further comprising scanning the laser source across a surface of the brown part.

Example 53. The hybrid material pump part according to Examples 26-52 wherein the laser source comprises a pulsed laser.

Example 54. The hybrid material pump part according to Examples 26-53 wherein the laser source comprises a high power carbon dioxide laser.

Example 55. The hybrid material pump part according to Examples 26-54 wherein the laser source comprises a pulsed high power carbon dioxide laser.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific aspects in which the disclosure can be practiced. These aspects are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description as examples or aspects, with each claim standing on its own as a separate aspect, and it is contemplated that such aspects can be combined with each other in various combinations or permutations. The scope of the disclosure should be determined with reference to the appended claims, along with the full scope of equivalents to which such claims are entitled.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

1. A process for constructing a hybrid material part comprising:
mixing a metal powder and a binder to form a compounded mixture;
heating the compounded mixture;
injecting the compounded mixture into a first mold to form a green part;
debinding the green part to form a brown part;
sintering the brown part to form a sintered part; and
over-molding the sintered part with a plastic in a second mold of an injection molding machine to form the hybrid material part.

2. The process according to claim 1 further comprising arranging the hybrid material part in a pump.

3. The process according to claim 2 wherein the pump comprises a variable displacement pump.

4. The process according to claim 2 further comprising arranging a pump drive hub and vanes within the hybrid material part, wherein the vanes are configured to contact the sintered part of the hybrid material part.

5. The process according to claim 2 further comprising forming fins on the sintered part to dissipate heat.

6. The process according to claim 1 wherein the sintering comprises selective sintering via localized heating.

7. The process according to claim 6 wherein the localized heating comprises heating with at least one of the following: a laser source and an infrared source.

8. The process according to claim 6 wherein the localized heating comprises heating with a laser source.

9. The process according to claim 1 wherein the sintering comprises selective sintering to a controlled thickness.

10. The process according to claim 1 wherein the sintered part comprises a sintered portion and a portion without sintering.

11. A hybrid material pump part comprising:
a first housing portion formed with a metal powder and a binder injection molded structure;
a second housing portion formed by a plastic structure over-molded onto the first housing portion;
a drive hub arranged in the first housing portion;
a plurality of slots arranged in the drive hub; and
a plurality of vanes arranged in the plurality of slots,
wherein the plurality of vanes form a seal with the first housing portion.

12. The hybrid material pump part according to claim 11 further comprising fins on the first housing portion configured to dissipate heat.

13. The hybrid material pump part according to claim 12 wherein the fins comprise a generally rectangular form.

14. The hybrid material pump part according to claim 12 wherein the fins extend radially outwardly from the first housing portion into the second housing portion.

15. The hybrid material pump part according to claim 11 wherein the drive hub is configured to rotate about an axis that is off-center with respect to a center of the first housing portion.

16. The hybrid material pump part according to claim 11 wherein the first housing portion comprises a sintered structure configured with selective sintering via localized heating.

17. The hybrid material pump part according to claim 16 wherein the localized heating comprises heating with at least one of the following: a laser source and an infrared source.

18. The hybrid material pump part according to claim 11 wherein the metal powder of the first housing portion comprises metal portions partially fused along a surface to other metal portions.

19. The hybrid material pump part according to claim 11 wherein the pump comprises a variable displacement pump.

20. The hybrid material pump part according to claim 11 wherein the first housing portion comprises a sintered portion and a portion without sintering.
